(19) United States
(12) Patent Application Publication
(10) Pub. No.: US 2016/0321688 A1
(43) Pub. Date: Nov. 3, 2016

(54) STATEMENT CREDIT

(71) Applicant: Discover Financial Services, Riverwoods, IL (US)

(72) Inventors: Brian Hughes, Glenview, IL (US); Ryan Scully, Chicago, IL (US); Miren Desai, Vernon Hills, IL (US); Julie Geraghty, Lake Bluff, IL (US); Gayle Prete, Chicago, IL (US); Diana Chen, Wilmette, IL (US)

(21) Appl. No.: 14/698,370

(22) Filed: Apr. 28, 2015

(51) Int. Cl. G06Q 30/02; G06Q 20/40; G06Q 20/24

(52) U.S. Cl. CPC G06Q 30/0215; G06Q 20/24; G06Q 20/405

(57) ABSTRACT

Systems and methods are provided that provide a credit card payment incentive system. The incentive system incentivizes a credit card member to pay down an outstanding balance quicker than it would typically be paid by making minimum payments against the outstanding balance. A financial system computing system is configured to receive payment data, which it parses to determine a payment amount made by the credit card member against the outstanding balance. The computing system reviews the payment amount against a minimum payment due to determine whether the payment amount qualifies as a qualified payment for purposes of applying a statement credit against the outstanding balance. If the payment amount qualifies as the qualified payment, the statement credit is applied against the outstanding balance.

### FIELD OF THE DISCLOSURE

This disclosure relates to credit card payment networks and, in particular, to a credit card incentive system.

### BACKGROUND

A certain percentage of credit card members carry a balance of funds due to a financial institution that provides the credit card. Typically, the financial institution charges the credit card member an interest amount against the balance of funds due on the credit card. Typically, the interest amount is applied as a percentage per annum against the balance of funds due. In this manner, the credit card member is incentivized to pay down the balance of funds due on the credit card in order to limit the additional funds due because of interest charges.

Furthermore, certain financial institutions offer various types of incentive systems designed to incentivize individuals to become credit card members of that financial institution. For instance, certain incentive systems offer airline miles or cash back for purchases made with an associated credit card. In this manner, individuals are incentivized to become credit card members and make purchases with that credit card.

In view of the need to pay down any balance of funds due on a credit card account in order to avoid interest charges, what is needed is an incentive system that incentivizes a credit card member to pay down their balance quicker. In this manner, the credit card member will both be incentivized to hold that credit card and pay down their balance of funds due quicker.

### SUMMARY

One embodiment provides a computer-implemented method for incentivizing a credit card member to pay more than a minimum amount due on a balance on their credit card, the method comprising: receiving a payment made by the credit card member against the balance on the credit card; determining whether the payment is a qualified payment; and conditionally applying a statement credit to the balance on the credit card when the payment is determined to be the qualified payment.

Another embodiment provides a non-transitory computer-readable storage medium storing instructions that when executed by a processor cause the computer system to incentivize a credit card member to pay more than a minimum amount due on a balance on their credit card, by performing the steps of: receiving a payment made by the credit card member against the balance on the credit card; determining whether the payment is a qualified payment; and conditionally applying a statement credit to the balance on the credit card when the payment is determined to be the qualified payment.

Yet another embodiment provides a financial transactions system comprising: a credit card member balance and payment database configured to store data for a plurality of balances on a plurality of credit cards for a plurality of credit card members; and a financial institution computing system configured to: receive payment data which includes a payment amount for at least one of the plurality of balances on the plurality of credit cards for the plurality of credit card members; determine whether the payment amount qualifies as a qualified payment; and apply a statement credit to the at least one of the plurality of balances when the payment amount qualifies as the qualified payment.

### BRIEF DESCRIPTION OF THE DRAWINGS

The accompanying drawings incorporated in and forming a part of the specification illustrate several aspects of the present disclosure and, together with the description, serve to explain the principles of the disclosure. In the drawings:

FIG. 1 is a schematic diagram of a financial institution configured to provide an incentive system, according to an embodiment of the disclosure;

FIG. 2 is a block diagram of a financial institution computing system, according to an embodiment of the disclosure;

FIG. 3 is an example of the incentive system, according to an embodiment of the disclosure; and

FIG. 4 is a flow chart for providing an incentive system, according to an embodiment of the disclosure.

### DETAILED DESCRIPTION

The following examples further illustrate embodiments of the disclosure but, of course, should not be construed as in any way limiting its scope.

Embodiments of the disclosure relate to an incentive system that incentivizes a credit card member to pay down their balance quicker. Aspects of the disclosure contained herein present such an incentive system. In one such aspect, a credit card member will be incentivized to make a greater than a minimum payment due, during a particular payment period, against a balance on a credit card by providing a statement credit against the balance due when the credit card member pays more than the minimum amount due.

In one embodiment, a credit card member of a financial institution will be prompted to join this statement credit incentive system based on meeting certain qualifying criteria such as carrying a balance of funds due on one or more credit card accounts either at the financial institution offering the incentive system or different financial institutions the individual has credit balances with. In this regard, the credit card member may enter this program by transferring balances held on different credit accounts to the credit account offered by the financial institution utilizing the statement credit incentive system. Also, the credit card member may take advantage of the incentive system by registering an already existing credit account from the financial institution with a balance of funds due in the statement credit incentive system.

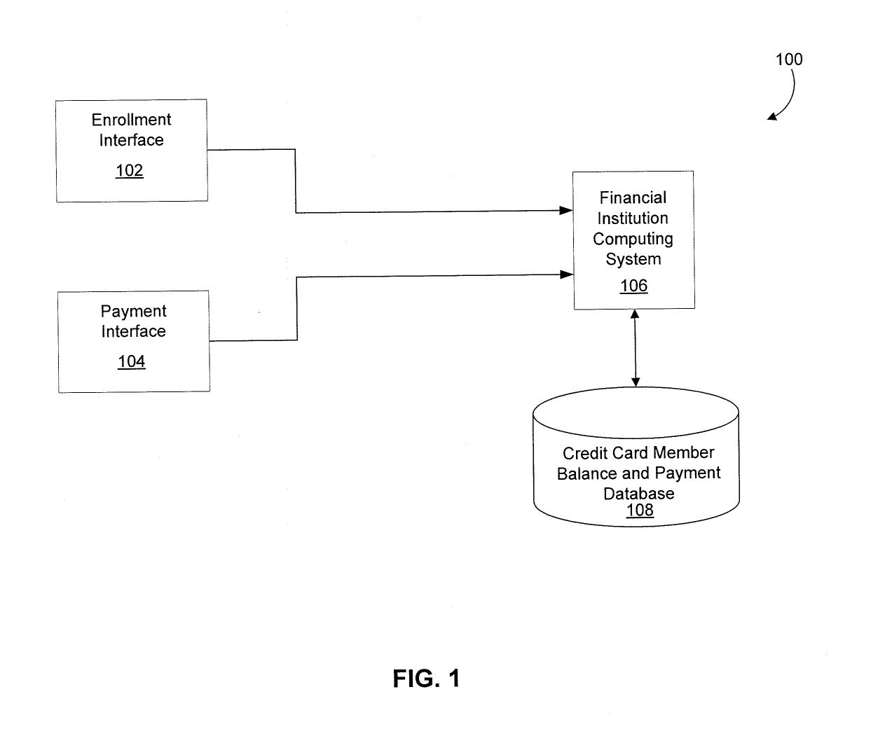

Turning now to FIG. 1, a financial system 100 for providing the aforementioned statement credit incentive system is illustrated. An enrollment interface 102 is provided such that potential credit card members or current credit card members of the financial institution can enroll in the statement credit incentive system. Enrollment can occur in a plurality of ways. For instance, in one embodiment, an enrollment offer letter is mailed or emailed to a current credit card member or potential credit card member to enroll in the incentive system, and upon receiving the letter, the current credit card member or potential credit card member is given the option to enroll a preexisting balance with the financial institution by performing a balance transfer into an account that takes advantage of the incentive system, or applying the incentive system to a preexisting account with the financial institution, for current credit card members. In other embodiments, the current credit card member or potential credit card member is contacted by a customer service representative at the financial institute about enrolling a preexisting balance in the incentive system. While in other embodiments, the current credit card member or potential credit card member contacts a customer service representative at the financial institute in order to enroll a balance in the incentive system. In these embodiments, the current credit card member or potential credit card member may contact the customer service representative after receiving promotional material regarding the incentive system from the financial institute.

Additionally, in certain embodiments, a current credit card member may have a preexisting balance automatically enrolled in the incentive system. In these embodiments, the financial institute may target certain credit card members who are at a higher risk for paying down a current balance. For instance, the higher risk assessment may be determined based on a total balance due or a financial ability to make regular payments on the balance. In some embodiments, the financial institute may contact the higher risk credit card member in order to inform them that they been enrolled automatically in the incentive system such that a statement credit will be applied to the balance on the account upon meeting certain conditions, such as making on time payments that are greater than the minimum amount due. In this regard, the financial institute will work with the higher risk credit card member in order to help them pay down the problematic balance quicker.

Regardless of how the current credit card member or potential credit card member is enrolled in the incentive system, enrollment data is received at the financial institution at the enrollment interface 102. The enrollment data received at the enrollment interface 102 pertains to identification information for the current credit card member or potential credit card member and a balance of funds due, or in other words an account balance, which will be transferred into the incentive system. The identification information of the enrollment data is entered into the enrollment interface 102 either by being scanned in if the acceptance is by mail, manually entered if the acceptance is by phone and automatically entered upon enrolling via an enrollment internet link in the email offer. The balance of funds due that will be transferred into the incentive system is provided when the current credit card member or potential credit card member either utilizes a balance transfer check specifically designed to pull funds from an account associated with the incentive system, performs a balance transfer over the phone with a customer service representative at the financial institute or initiates an online balance transfer via an account access interface for the account associated with the incentive system.

After the enrollment interface 102 receives the enrollment data, it sends the enrollment data to a financial institution computing system 106 or in other words computing system 106. The computing system 106 is illustrated as a single entity such as a single server; however, in certain embodiments, the computing system 106 may include one or more servers clustered together into a datacenter or may further be configured as a cloud server. Regardless of the configuration, the computing system 106 recognizes the enrollment data and parses account balance and the identification information and enters that data into a credit card member balance and payment database 108, or in other words database 108.

Database 108 then stores the data related to the balance of funds due under the incentive system and the identification information for each of a plurality of credit card members utilizing the incentive system. In this manner, each of the plurality of credit card members are stored in database 108 along with their associated account balance under the incentive system.

As an aside, in certain embodiments, enrollment of a balance of funds due in the statement credit incentive system will be indefinite; however, in other embodiments, the enrollment in the statement credit incentive system will be for a predetermined period of time. For instance, in some embodiments, the enrolled account may be eligible for the statement credit for a period of time provided in any promotional material that enticed the credit card member to transfer a balance into the incentive system. By way of example, in some embodiments where the credit card member enrolls via a balance transfer promotional, that credit card member may be enrolled in the incentive system for as long as a promotional annual percentage rate (APR) is provided on the balance transfer offer. For instance, in the this embodiment, the credit card member transferring in a balance on a balance transfer offer that provides for a 0% APR for 18 months on the transferred funds would also be enrolled in the incentive system for the same 18 months.

After a credit card member is enrolled in the incentive system, and the account balance along with the identification information is stored in the database 108 for access by the computing system 106, a minimum amount due and a due date for that amount may be determined by the computing system 106 or various other systems at the financial institution, and the minimum amount due is associated with the balance data for each member of the plurality of credit card members stored in the database 108. The minimum amount due and a due date are communicated to each credit card member of the plurality of credit card members such that each credit card member can set up a payment toward the balance of funds due. Typically, each individual credit card member will set up payment either as an electronic debit from a checking or savings account or mail a physical check in to the financial institute. Further, this payment is usually for a sum of funds at or greater than the minimum amount due. In this regard, the payment includes payment data, which includes a payment representing a sum of funds being applied toward that credit card member's balance of funds due and identification information of the credit card member making the payment.

Regardless of whether the payment is made electronically or via the mail, once the payment data reaches the financial institution it is entered into a payment interface 104. The payment data is either scanned into the payment interface 104 in the event that payment is made with a physical check or entered directly into the payment interface 104 if the payment is made electronically along with identification information of the credit card member making that payment. Further, in certain embodiments, a credit card member enrolled in the incentive system may make a payment over the telephone with either a live customer service representative or a telephone based computerized payment system at the financial institute. In these embodiments, the payment data is entered into the payment interface 104 during the phone based payment process.

In turn, the payment interface 104 then supplies the payment data including the payment along with the identification information of the credit card member making the payment to the computing system 106. The computing system 106 then proceeds to parse the identification information and reference the database 108 in order to find the associated credit card member enrolled in the incentive system and the associated minimum amount due and the due date for the payment. If the computing system 106 determines that the identification information matches a credit card member taking advantage of the incentive system, then the computing system 106 parses the payment data to determine the payment amount and compares it against the minimum amount due during the current pay period to determine whether the payment data is a qualified payment, which means that it is greater than the minimum amount due. And if the payment data is a qualified payment, then computing system applies a statement credit to the balance of funds due. Further, in some embodiments, the computing system 106 further determines whether the payment was made prior to the due date, and if it is not prior to the due date, then the statement credit is not applied regardless of whether the payment amount is a qualified payment.

The computing system 106 performs this determination and conditional application of the statement credit for each credit card member of the plurality of credit card members stored in database 108. In this regard, the computing system is configured to simultaneously determine eligibility for and application of the statement credit for each credit card member of the plurality of credit card members based on the received enrollment data and payment data. Accordingly, in this manner, in certain embodiments, the statement credit is applied by the computing system 106 efficiently and autonomously for each credit card member of the plurality of credit card members enrolled in the incentive system.

As an aside, a qualified payment may be made when the payment amount is greater than the minimum amount due by any amount less than or equal to the total balance of funds due against the account. In this regard, in certain embodiments, the statement credit may be given when the payment data indicates the payment is at least $0.01 over the minimum amount due.

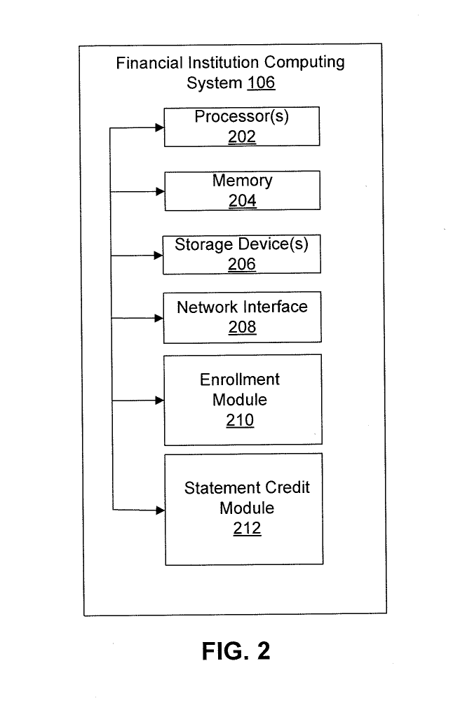

Moving to FIG. 2, a block diagram of basic functional components for the computing system 106 is depicted, according to one embodiment of the disclosure. The computing system 106 includes one or more processors 202, a memory 204, one or more storage device(s) 206 and a network interface 208. Additionally, the computing system 106 further includes an enrollment module 210 and a statement credit module 212. In certain embodiments, each of the components including the processor(s) 202, the memory 204, the storage device 206, the network interface 208, the enrollment module 210 and the statement credit module 212 are interconnected physically, communicatively, and/or operatively for inter-component communications.

As illustrated, processor(s) 202 are configured to implement functionality and/or process instructions for execution within computing system 106. For example, processors 202 execute instructions stored in memory 204 or instructions stored on storage devices 206. For instance, in certain embodiments, the processor(s) 202 are configured with instructions to determine minimum amounts due on credit card accounts with an outstanding balance due and a due date during a payment period for that account. The processor(s) 202 are further configured with instructions to cause the computing system 106 to update the database 108 with the minimum amount due and the due date for that amount and also to provide the minimum amount due and due date to the credit card member by causing correspondence to be provided to the credit card member containing the minimum amount due during a pay period and when at least that amount is due.

Memory 204, which may be a non-transient, computer-readable storage medium, is configured to store information within computing system 106 during operation. In some embodiments, memory 204 includes a temporary memory, i.e. an area for information not to be maintained when the server 106 is turned off Examples of such temporary memory include volatile memories such as random access memories (RAM), dynamic random access memories (DRAM), and static random access memories (SRAM). Memory 204 also maintains program instructions for execution by the processor(s) 202. Indeed, in certain embodiments, the database 108 is implemented in the memory 204, while in other embodiments, the database 108 is a separate storage device.

Storage device(s) 206 also include one or more non-transient computer-readable storage media. Storage devices 206 are generally configured to store larger amounts of information than memory 204. Storage devices 206 may further be configured for long-term storage of information. In certain examples, storage devices 206 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories. Indeed, in certain embodiments, the database 108 is implemented in the storage device(s) 206, while in other embodiments, the database 108 is a separate storage device.

The computing system 106 uses network interface 208 to communicate with external systems and interfaces, such as the enrollment interface and the payment interface, via one or more data communication networks. Such data communication networks may include one or more wireless networks, wired networks, fiber optics networks, and other types of networks through which communication between the computing system 106 and an external system or interface may be established. Further, in certain embodiments, the network interface 208 may be a network interface card, such as an Ethernet card, an optical transceiver, a radio frequency transceiver, or any other type of device that can send and receive information.

The computing system 106 further includes the enrollment module 210. The enrollment module 210 receives the enrollment data from the enrollment interface 102 (see FIG. 1). After receiving the enrollment data, the enrollment module 210 parses the identification information and the account balance and populates that data into the database 108.

As an aside, while the enrollment module 210 is illustrated in FIG. 2 as being separate from the processor(s) 202, in certain embodiments, the enrollment module 210 may be represented as an operational state or states of the processor(s) 202. In this regard, the functions of the enrollment module 210 may be defined by instructions stored on the memory 204 or the storage device 206 and executed by the processor(s) 202 in order to perform the above discussed functions of the enrollment module 210.

The computing system 106 further includes the statement credit module 212. The statement credit module 212 receives the payment data from the payment interface 104 (see FIG. 1). The statement credit module 212 utilizes the identification information contained in the payment data to reference the minimum amount due on the account, as previously determined by the computing system 106 and stored in the database 108. After identifying an individual credit card member making payment, the statement credit module 212 proceeds to parse the sum of funds made as payment from the payment data and compare that sum to the minimum amount due on the balance in the account in order to determine whether the payment is a qualified payment. And if the payment is a qualified payment such that it is greater than the minimum amount due on the balance of the account, the statement credit module 212 determines a statement credit and applies it to the balance of funds due on the account.

Further, in certain embodiments, the payment data further includes a date that the payment is made, and the statement credit module 212 further determines whether the date the payment is made is prior to or on the due date for the payment. And if the payment is after the due date, then the statement credit module does not apply the statement credit regardless of whether the payment is a qualified payment.

As an aside, while the statement credit module 212 is illustrated in FIG. 2 as being separate from the processor(s) 202, in certain embodiments, the statement credit module 212 may be represented as an operational state or states of the processor(s) 202. In this regard, the functions of the statement credit module 212 may be defined by instructions stored on the memory 204 or the storage device 206 and executed by the processor(s) 202 in order to perform the above discussed functions of the statement credit module 212.

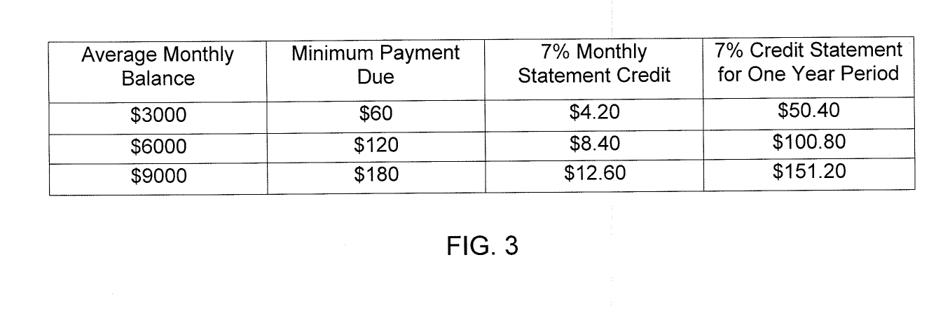

Moving to FIG. 3, an embodiment of the statement credit incentive system is illustrated. Specifically, FIG. 3 illustrates a table containing three separate balance scenarios, one for $3000, $4000 and $9000 with minimum payments due of $60, $120 and $180, respectively. In the illustrated embodiment, the statement credit is applied as a percentage of the minimum amount due during the outstanding payment period. Specifically, in the illustrated embodiment, the statement credit is 7% of the minimum amount due during that payment period. Accordingly, the 7% statement credit applied if the credit card member makes a payment greater than the minimum amount due is $4.20, $8.40 or $12.60, respectively for the $3000, $4000 and $9000 balance scenarios. Further, a column containing the benefits under the incentive system of making greater than the minimum payments over the course of one year is illustrated. In the illustrated embodiment, if the credit card member makes the greater than minimum payment each month for a year, the 7% statement credit will add up to $50.40, $100.80 and $151.20 for the $3000, $4000 and $9000 balance scenarios, respectively.

While the illustrated embodiment provides for a 7% of the minimum payment due as a statement credit, in other embodiments, other percentages are contemplated. For instance, the statement credit may be determined as 5% of the minimum payment due. In other embodiments, the statement credit may be a flat sum applied after any consecutive number of payment periods of greater than minimum payments being made. For instance, in certain embodiments, after four consecutive months, where each month is a different payment period, of greater than minimum payments being made, a statement credit of $10 may be applied to the balance. In certain embodiments, both the monthly percentage and the flat sum may be applied in conjunction. For instance, in certain embodiments, a credit card member that makes a greater than minimum payment due for four consecutive months will receive a 5% of the minimum payment due statement credit each month and an additional $10 flat sum statement credit applied after the four months of greater than minimum payments.

As an aside, while the above discussion regarding FIG. 3 mentions various embodiments utilizing a 5% or 7% of the minimum payment due as a statement credit, other percentages are contemplate. For instance, any percentage from greater than 0 up to and including 100% of the minimum payment due are contemplated as a statement credit in various embodiments. In other embodiments, a statement credit greater than the minimum payment due is contemplated. Further, the flat sum is discussed as being $10; however, any sum from greater than $0 up to the total minimum payment due or even up to the balance due on the account are contemplated as the flat sum, in certain embodiments.

Additionally, regarding the percentage of the minimum payment due as the statement credit, in certain embodiments, the percentage may be determined based on the total balance due on the account. For instance, in certain embodiments, the statement credit may be determined as 5%, 7% or any percentage from just greater than 0 up to 100% of the total balance due on the account.

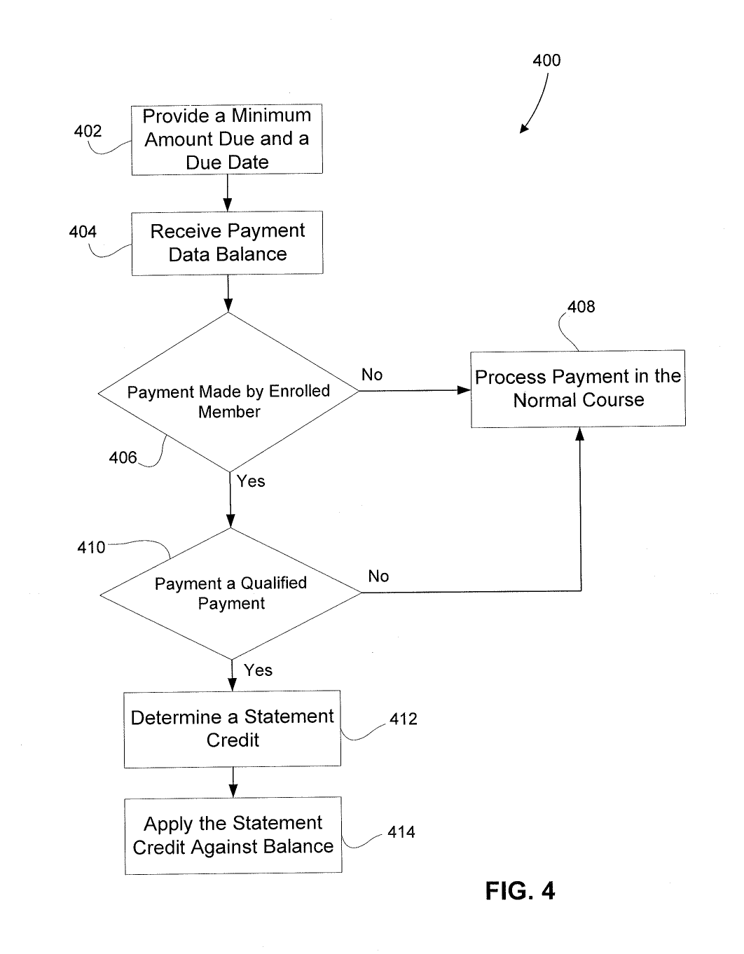

Moving to FIG. 4, a flow chart 400 for providing a statement credit for a credit card member enrolled in an incentive program is illustrated. In the illustrated embodiment, the flow chart 400 is performed by the computing system 106 (see FIG. 1). At step 402, the computing system 106 provides a credit card member with a minimum payment amount due and a due date for that payment. In this regard, the computing system 106 may cause an internet account interface for the credit card member to display the minimum payment amount and due date and/or cause mail correspondence containing the minimum payment amount due and a due date to be mailed to the credit card member.

Subsequent to step 402, the credit card member makes the payment, and at step 404, the computing system 106 (see FIG. 1) receives that payment data from the payment interface 104, and, at step 406, determines whether the payment data pertains to a credit card member enrolled in the incentive system. This determination is made by utilizing the identification information in the received payment data and cross-referencing the identification information of the enrolled members stored in the database 108. If it is determined that the payment was made by a credit card member not enrolled in the incentive system, then the flow chart 400 proceeds to step 408 where the computing system 106 processes the payment in the normal course by applying the payment against the balance of funds due but not applying the statement credit. However, if it is determined at step 406 that the identification information in the payment data belongs to an enrolled credit card member in database 108, then the flow chart 400 proceeds to step 410.

At step 410, the computing system 106 (see FIG. 1) determines whether the payment amount in the payment data is a qualified payment, or in other words, is greater than the minimum amount due during that payment period. If the payment is determined to not be a qualified payment, then the flow chart 400 proceeds to step 408 where the payment is processed in the normal course against the balance of funds due on the credit card account. However, if the payment is determined to be a qualified payment, then the flow chart proceeds to step 412.

At step 412, the computing system 106 (see FIG. 1) determines a statement credit to be applied to the balance of the credit card account. As discussed above in reference to FIG. 3, the statement credit, in certain embodiments, is determined as a percentage of the minimum payment due for that payment period, such as 5% or 7% of the minimum payment due. While in other embodiments, the statement credit is a flat sum applied to the balance on the credit card account either upon making a qualified payment or upon making a series of qualified payments over several payment periods. Or, in other embodiments, the statement credit may be both the percentage of the minimum amount due and the flat sum applied to the balance due on the credit card account.

At step 414, the computing system 106 (see FIG. 1) applies the statement credit against the balance on the credit card account. In some embodiments, the statement credit is only applied if the payment is made on or before the due date provided to the credit card member at step 402. Further, in certain embodiments, there is only a single interest rate associated with the entirety of the balance, and in these embodiments, the statement credit is applied to the single balance. However, in other embodiments, the balance is made up of multiple sub-balances at different associated interest rates. In these embodiments, the statement credit may be applied against the sub-balance with the highest associated interest rate first so to pay down that high interest rate sub-balance prior to the lower interest rate sub-balances.

One or more embodiments of the disclosure may be implemented on one or more computer-readable media executed by one or more processors.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computer-implemented method for incentivizing a credit card member to pay more than a minimum amount due on a balance on their credit card, the method comprising:
receiving a payment made by the credit card member against the balance on the credit card;
determining whether the payment is a qualified payment; and
conditionally applying a statement credit to the balance on the credit card when the payment is determined to be the qualified payment.

2. The method of claim 1, further comprising providing a minimum amount due during a payment period for the balance on the credit card to the credit card member.

3. The method of claim 2, wherein the qualified payment is a payment amount greater than the minimum amount due during the payment period.

4. The method of claim 3, wherein the payment amount is greater than the minimum amount due by at least $0.01.

5. The method of claim 2, further comprising conditionally determining the statement credit to the balance as a percentage of the minimum amount due during the payment period when the payment is determined to be the qualified payment.

6. The method of claim 5, wherein the percentage of the minimum amount due is 7%.

7. The method of claim 5, wherein the percentage of the minimum amount due is 5%.

8. The method of claim 2, further comprising providing a due date during the payment period for the payment made by the credit card member.

9. The method of claim 8, wherein the statement credit to the balance on the credit card is only applied if the payment made by the credit card member is made on or before the due date.

10. The method of claim 1, wherein the balance comprises more than one sub-balance with each sub-balance having an associated interest rate at which interest is charged on the sub-balance.

11. The method of claim 10, wherein the statement credit is applied against a highest associated interest rate sub-balance.

12. A non-transitory computer-readable storage medium storing instructions that when executed by a processor cause the computer system to incentivize a credit card member to pay more than a minimum amount due on a balance on their credit card, by performing the steps of:
receiving a payment made by the credit card member against the balance on the credit card;
determining whether the payment is a qualified payment; and
conditionally applying a statement credit to the balance on the credit card when the payment is determined to be the qualified payment.

13. The computer-readable storage medium of claim 12, further comprising instructions for providing a minimum amount due during a payment period for the balance on the credit card to the credit card member.

14. The computer-readable storage medium of claim 13, wherein the qualified payment is a payment amount greater than the minimum amount due during the payment period.

15. The computer-readable storage medium of claim 13, further comprising instructions for conditionally determining the statement credit to the balance as a percentage of the minimum amount due during the payment period when the payment is determined to be the qualified payment.

16. The computer-readable storage medium of claim 13, further comprising instructions for providing a due date during the payment period for the payment made by the credit card member.

17. The computer-readable storage medium of claim 16, wherein the statement credit to the balance on the credit card is only applied if the payment made by the credit card member is made on or before the due date.

18. A financial transactions system comprising:
a credit card member balance and payment database configured to store data for a plurality of balances on a plurality of credit cards for a plurality of credit card members; and
a financial institution computing system configured to:
receive payment data which includes a payment amount for at least one of the plurality of balances on the plurality of credit cards for the plurality of credit card members;
determine whether the payment amount qualifies as a qualified payment; and
apply a statement credit to the at least one of the plurality of balances when the payment amount qualifies as the qualified payment.

19. The financial transactions system of claim 18, wherein the data stored in the credit card member balance and payment database comprises, for each of the plurality of credit cards, a minimum amount due during a payment period for an individual credit card of the plurality of credit cards.

20. The financial transactions system of claim 19, wherein the payment amount is the qualified payment when the payment amount is greater than the minimum amount due during the payment period.
